(19) United States
(12) Patent Application Publication
(10) Pub. No.: US 2012/0054824 A1
(43) Pub. Date: Mar. 1, 2012

(54) ACCESS CONTROL POLICY TEMPLATE GENERATING DEVICE, SYSTEM, METHOD AND PROGRAM

(76) Inventor: Ryo Furukawa, Tokyo (JP)

(21) Appl. No.: 13/262,955

(22) PCT Filed: Mar. 12, 2010
(86) PCT No.: PCT/JP2010/001781

§ 371 Date: Nov. 9, 2011

(30) Foreign Application Priority Data
Apr. 10, 2009 (JP) 2009-096126

(51) Int. Cl. G06F 21/00

(52) U.S. Cl. 726/1

(57) ABSTRACT

An access control policy generating device includes: a resource grouping unit which, when a plurality of access control policies including access control content defined for resources are given, classifies each resource into one or more groups based on a similarity between resource specific access control policy sets calculated using, as a comparison target, the access control content of the access control policies included in the resource specific access control policy sets including access control policies of a same resource among the plurality of access control policies; and a template generating unit which generates an access control policy template based on definition content of the access control policies defined for the resources included in a resource group per resource group which is a group of the resources classified by the resource grouping unit.

### TECHNICAL FIELD

The present invention relates to an access control policy template generating device, an access control policy management system, an access control policy template generating method and an access control policy template generating program for generating a template of an access control policy.

### BACKGROUND ART

Applying a setting of an access control policy which defines, for example, an access right according to a template-based method based on a template of an access control policy created in advance (hereinafter “policy template”) makes it unnecessary to input the same setting from an administrator of an access right management system again and again and reduces policy setting cost.

For example, Patent Literature 1 discloses an example of a system of setting an access control policy based on a template.

Further, Patent Literature 2 discloses a method of, when the similarity of two policy sets is found and is a threshold or more, generating a policy set which can be used for replacement of the two policy sets based on a policy pair in each policy set.

### CITATION LIST

### Patent Literature

PLT 1: Japanese Patent Application Laid-Open No. 2004-133816

PLT 2: Japanese Patent Application Laid-Open No. 2007-072581

### SUMMARY OF INVENTION

### Technical Problem

However, the system disclosed in Patent Literature 1 has a problem of having difficulty in creating a policy template. Although creating a policy template requires knowledge related to a policy which is currently in operation, if there are multiple targets (hereinafter, resources) such as servers or folders for which access control policies are set, the total amount of policies becomes enormous, and, if the knowledge is not succeeded due to replacement of an administrator, it is difficult to learn what services there are.

The access control policy is usually set per service such as a departmental Web content and information service for affiliated companies. Further, when a resource is added, a service provided using the resource to be added is usually determined in advance, and, if a policy template is created in advance per service, it is easy to select a policy template used by the administrator for the resource to be added.

When, for example, a template is created per service to support a Web service for a department 1 or to support folders for the department 1, if for what use and for which user (for example, for the department 1 as a web server) a server is added is determined to add a new server, it is possible to easily apply a policy to a server to be added by selecting and using the template supporting this service.

In view of this, the policy template is preferably created according to classification of a service which is learned based on an existing policy.

In addition, by using the method disclosed in Patent Literature 2, it is possible to create an identical policy between two policy sets as a template. However, the method disclosed in Patent Literature 2 is directed to generating a policy set which can be used at least for replacement of two policy sets, and does not take into account reading of classification of a service based on setting content of each policy set with reference to numerous policy sets. Therefore, the method disclosed in Patent Literature 2 is directed to merely comparing two policy sets, and therefore cannot create a template according to service classification.

It is therefore an object of the present invention to provide an access control policy template generating device, an access control policy management system, an access control policy template generating method and an access control policy template generating program for creating a policy template matching service classification which is learned from an existing policy.

### Solution to Problem

An access control policy template generating device according to the present invention includes: resource grouping means which, when a plurality of access control policies including access control content defined for resources are given, classifies each resource into one or more groups based on a similarity between resource specific access control policy sets calculated using, as a comparison target, the access control content of the access control policies included in the resource specific access control policy sets including access control policies of a same resource among the plurality of access control policies; and template generating means which generates an access control policy template based on definition content of the access control policies defined for the resources included in a resource group per resource group which is a group of the resources classified by the resource grouping means.

An access control policy management system according to the present invention including an access control policy template generating device which includes: resource grouping means which, when a plurality of access control policies including access control content defined at least for resources are given, classifies each resource into one or more groups based on a similarity between resource specific access control policy sets calculated using, as a comparison target, the access control content of the access control policies included in the resource specific access control policy sets including access control policies of a same resource among the plurality of access control policies; and template generating means which generates an access control policy template based on definition content of the access control policies defined for the resources included in a resource group per resource group which is a group of the resources classified by the resource grouping means, and includes: resource registering means which registers a new resource; template selecting means which selects an access control policy template to be applied to the new resource registered in the resource registering means from the access control policy template generated by the access control policy template generating device according to a user's operation; and access control policy generating means which edits the access control policy template selected by the template selecting means according to the user's operation, and generates an access control policy to be applied to the new resource registered in the resource registering means.

An access control policy template generating method according to the present invention includes: when a plurality of access control policies including access control content defined for resources are given, classifying each resource into one or more groups based on a similarity between resource specific access control policy sets calculated using, as a comparison target, the access control content of the access control policies included in the resource specific access control policy sets including access control policies of a same resource among the plurality of access control policies; and generating an access control policy template based on definition content of the access control policies defined for the resources included in a resource group per resource group which is a group of the classified resources.

An access control policy template generating program according to the present invention causes a computer including storage means which stores a plurality of access control policies including access control content defined for resources to execute: resource grouping processing for classifying each resource into one or more groups based on a similarity between resource specific access control policy sets calculated using, as a comparison target, the access control content of the access control policies included in the resource specific access control policy sets including access control policies of a same resource among the plurality of access control policies; and template generating processing for generating an access control policy template based on definition content of the access control policies defined for the resources included in a resource group per resource group which is a group of the classified resources.

### Advantageous Effects of Invention

According to the present invention, it is possible to create a policy template matching service classification which is learned from an existing policy.

### BRIEF DESCRIPTION OF DRAWINGS

FIG. 1 is a block diagram illustrating a configuration example of a policy template generating device according to a first exemplary embodiment of the present invention.

FIG. 2 is a flowchart illustrating an example of an operation (entire operation) according to the first exemplary embodiment.

FIG. 3 is a flowchart illustrating an example of an operation (resource group generating processing) according to the first exemplary embodiment.

FIG. 4 is a flowchart illustrating an example of an operation (inter-resource distance calculating processing) according to the first exemplary embodiment.

FIG. 5 is a flowchart illustrating an example of an operation (resource group generating processing from a resource classification tree) according to the first exemplary embodiment.

FIG. 6 is a flowchart illustrating an example of an operation (upper node set extracting processing from a resource classification tree) according to the first exemplary embodiment.

FIG. 7 is a flowchart illustrating an example of an operation (template generating processing) according to the first exemplary embodiment.

FIG. 8 is a block diagram illustrating a configuration example of an access right management system according to the first exemplary embodiment.

FIG. 9 is an explanatory view illustrating an example of a policy set stored in policy storing means.

FIG. 10 is an explanatory view illustrating an example of a resource classification tree generated from the policy set illustrated in FIG. 9.

FIG. 11 is an explanatory view illustrating an example of information showing a resource group generated from the policy set illustrated in FIG. 9.

FIG. 12 is an explanatory view illustrating an example of a policy template generated from the policy set illustrated in FIG. 9.

FIG. 13 is a flowchart illustrating an example Of a policy setting operation utilizing the generated policy template.

FIG. 14 is an explanatory view illustrating an example of a template selection screen provided by template selecting means.

FIG. 15 is an explanatory view illustrating an example of a policy set to a router upon addition of a resource.

FIG. 16 is a block diagram illustrating another configuration example of an access right management system according to a second exemplary embodiment.

FIG. 17 is an explanatory view illustrating an example of a template naming screen provided by template naming means.

FIG. 18 is a block diagram illustrating an outline of the present invention.

FIG. 19 is a block diagram illustrating another configuration example of an access control policy template generating device according to the present invention.

FIG. 20 is a block diagram illustrating a configuration example of an access control policy management system according to the present invention.

### Description of Embodiments

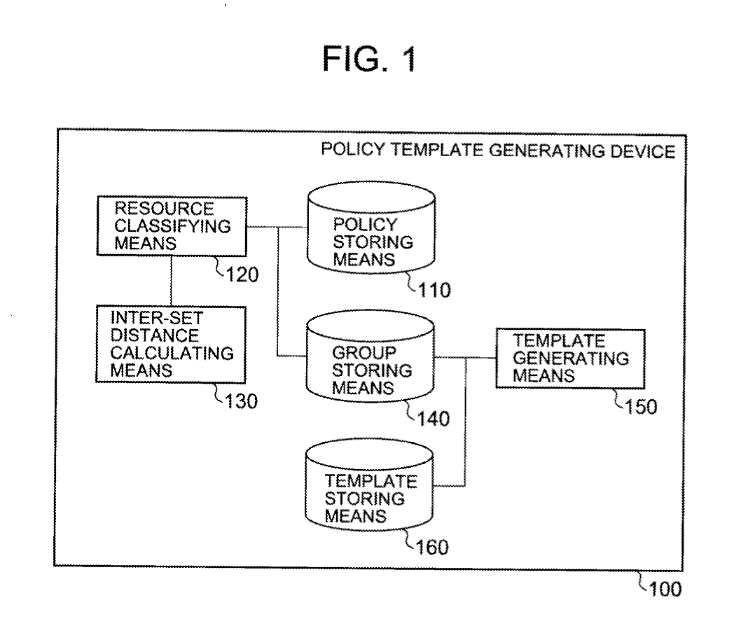

Hereinafter, an exemplary embodiment of the present invention will be described with reference to the drawings. FIG. 1 is a block diagram illustrating a configuration example of a policy template generating device according to a first exemplary embodiment of the present invention. As illustrated in FIG. 1, the policy template generating device 100 has policy storing means 110, resource classifying means 120, inter-set distance calculating means 130, group storing means 140, template generating means 150 and template storing means 150.

The policy storing means 110 stores information of an access control policy which is currently set.

The resource classifying means 120 refers to the access control policy stored in the policy storing means 110, and groups a set of pairs of access sources and actions (hereinafter, “permissions”) per resource described in the access control policy in operation, using as a reference the inter-resource distance calculated by the inter-set distance calculating means 130 (generates a resource group).

The group storing means 140 stores information of the resource group generated by the resource classifying means 120.

The inter-set distance calculating unit 130 receives the permission set per resource from the resource classifying means 120, calculates the distance between two permission sets and returns the distance to the resource classifying means 120 as an inter-resource distance. In addition, with the present exemplary embodiment, this inter-resource distance is used as a reciprocal of the similarity. That is, the inter-resource distance is calculated as a distance which increases as setting content (with the present exemplary embodiment, an access source and an access method to be permitted) which is not common between access right policies for respective resources increases. That is, this means that, as the inter-resource distance increases, the similarity (the degree of similarity) decreases.

The template generating means 150 generates a template by extracting a permission which is common between all resources in a resource group generated by the resource classifying means 120. Further, the template storing means 160 stores information of the generated template.

The template storing means 160 stores information of the template generated by the template generating means 150.

In addition, with the present exemplary embodiment, the resource classifying means 120, inter-set distance calculating means 130 and template generating means 150 are realized by, for example, a CPU which operates according to, for example, a program. Further, the policy storing means 110, group storing means 140 and template storing means 160 are realized by, for example, storage means such as a memory.

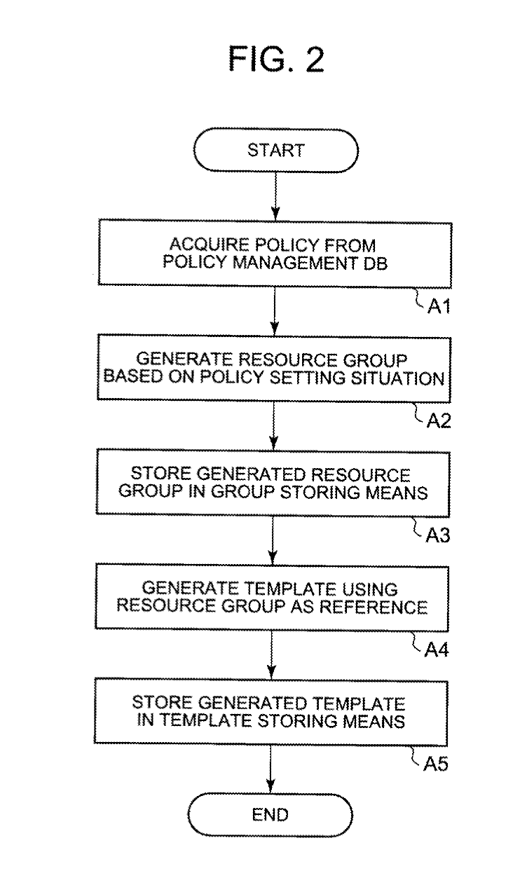

Next, the operation according to the present exemplary embodiment will be described. FIG. 2 is a flowchart illustrating an example of the operation according to the present exemplary embodiment. FIG. 2 illustrates an entire operation example according to the present exemplary embodiment. As illustrated in FIG. 2, first, the resource classifying means 120 acquires an access control policy from the policy storing means 110 (step A1). In addition, the access control policy stored in the policy storing means 110 is currently set in a system or device which is a target to apply a template.

Next, a resource group is generated using the acquired policy (step A2). Further, the resource classifying means 120 stores information of the generated resource group in the group storing means 140 (step A3).

When the resource group is generated, the template generating means 150 extracts a permission commonly set in all resources in the resource group based on information of the resource groups stored in the group storing means 140, and generates a template (step A4). Finally, the generated template is stored in the template storing means 160 and processing is finished (step A5).

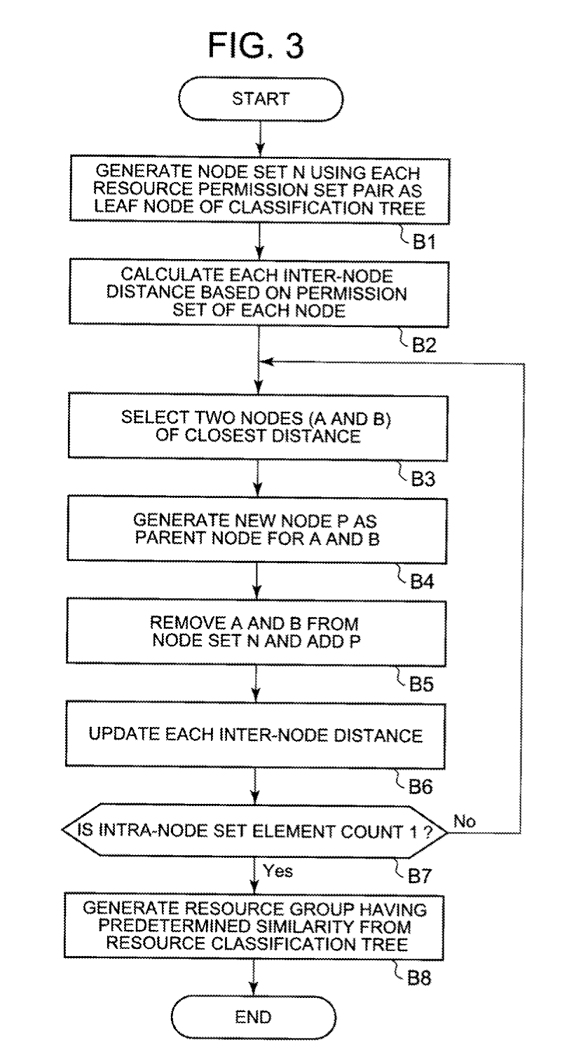

Next, processing of generating a resource group in the resource classifying means 120 will be described with reference to the flowchart illustrated in FIG. 3. FIG. 3 is the flowchart illustrating an example of a processing flowchart of resource group generating processing. As illustrated in FIG. 3, first, the resource classifying means 120 makes pairs of all resources and permission sets as leaf nodes of a classification tree, and generates a node set N (step B1).

Next, all inter-resource distances are calculated using the inter-set distance calculating means 130, and are set as the distance between corresponding leaf nodes (step B2). Meanwhile, the distance between two nodes is a maximum inter-resource distance (farthest distance) when an arbitrary resource is extracted one by one from a resource set associated with a leaf node included subtree at a level equivalent to or below the two nodes or less and all distances between two resources in the resource set are measured, and an inter-leaf node distance is equal to a corresponding inter-resource distance.

Further, processings in steps B3 to B6 are repeated until the element count in a node set becomes one (No in step B7).

In step B3, first, two nodes (hereinafter, nodes A and B) having the closest inter-node distance are selected from the node set N. Next, a new node P is generated as a parent mode of the nodes A and B (step B4). Further, the nodes A and B are removed from the node set N, and a node P is added to update the node set (step B5).

Further, the distance between the node P and each node in the node set to update the inter-node distance (step B6).

Further, when the element count in the node set becomes one (Yes in step B7), a resource classification tree structured at this point of time is outputted (step B8). With the resource classification tree to be outputted, this element becomes a root node of the resource classification tree and all leaf nodes are included in one classification tree.

The resource classifying means 120 separates a subtree from the resource classification tree outputted from the inter-set distance calculating means 130 such that the distances between all nodes in the subtree become a threshold or less, and generates a set of resources associated with leaf nodes included in the subtree as one resource group (step B9).

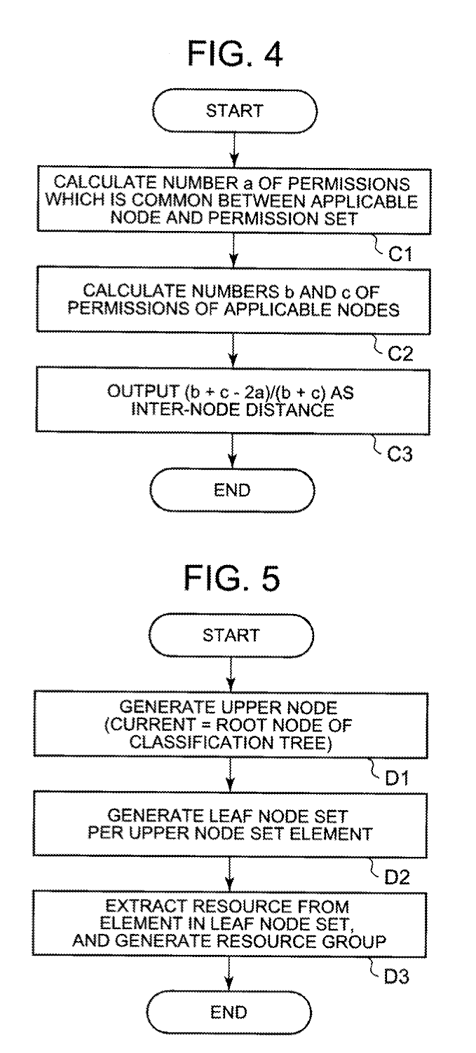

Next, a method of calculating the inter-leaf distance (that is, the inter-resource distance) in the inter-set distance calculating means 130 will be described. The inter-set distance calculating means 130 calculates the distance which increases following an increase in the rate of the non-common element count between permission sets of two resources. This distance may be calculated according to, for example, the method illustrated in the flowchart in FIG. 4.

FIG. 4 is a flowchart illustrating an example of a processing flowchart of calculating processing of an inter-resource distance. As illustrated in FIG. 4, the inter-set distance calculating means 130 first calculates the number a of permissions which are set and commonly exist in two resources (step C1). Next, the numbers b and c of permissions set respectively in two resources are calculated (step C2).

Finally, the following Math. 1 is calculated using the calculated numbers a, b and c, the calculation result is outputted as the distance between two resources and processing is finished (step C3).

(b+c−2a)/(b+c) [Math. 1]

In addition, although an example has been described with the present example where the inter-set distance is calculated using permissions (that is, a set of an access source and action) as a comparison target, it is also possible to calculate the inter-set distance using, for example, only an access source as a comparison target.

Next, processing (step B9 in FIG. 3) of generating a resource group from a resource classification tree in the resource classifying means 120 will be further described. FIG. 5 is a flowchart illustrating an example of processing of generating a resource group from a resource classification tree.

As illustrated in FIG. 5, the resource classifying means 120 first extracts a set of nodes (hereinafter “upper nodes”) which are root nodes of each subtree to separate the resource classification tree based on the inter-node distance (step D1). In step D1, an upper node generation processing function which will be described below needs to be invoked using, for example, root nodes of the resource classification tree as arguments. Next, a set of leaf nodes belonging to subtrees is generated using each upper node as a root node from the upper node set (step D2).

Further, by grouping resources associated with each leaf node per leaf node set, a resource group is generated (step D3).

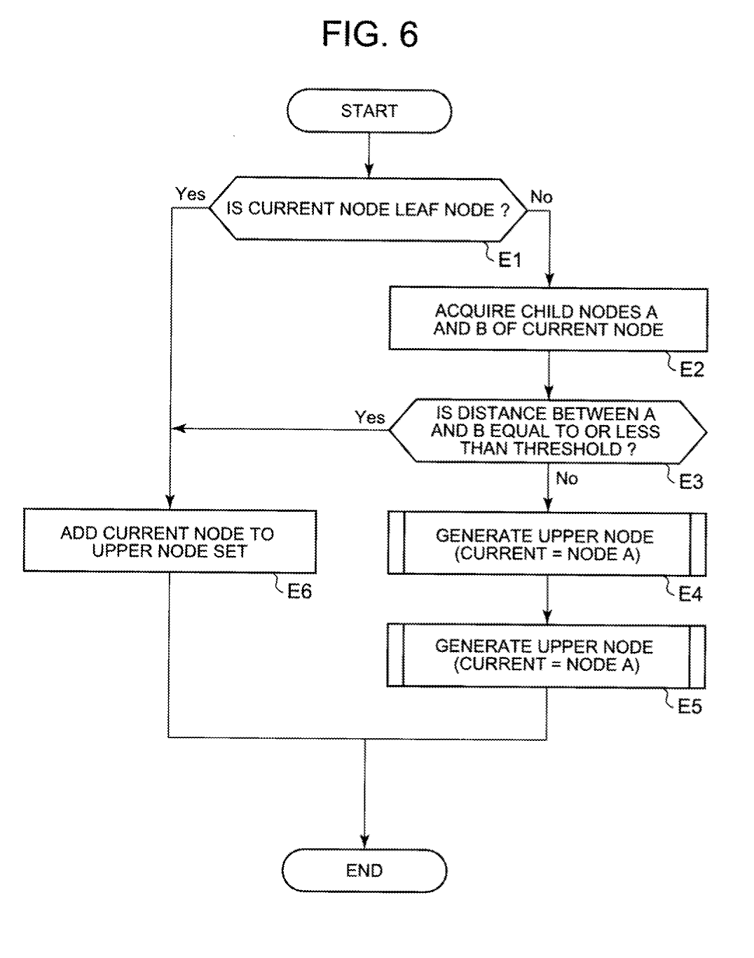

Next, processing of extracting the upper node set in step D1 will be described. With the present exemplary embodiment, the extracting processing is performed by invoking the upper node generating processing illustrated in FIG. 6. FIG. 6 is a flowchart illustrating an example of a processing flowchart of the upper node generating processing (that is, processing of extracting the upper node set) from the resource classification tree. First, whether a node (current node) which is determined to be a current upper node is a leaf node is determined (step E1). When the current node is determined to be a leaf node (Yes in step E1), the current node is added to the upper node set (step E6).

By contrast with this, when the current node is determined to be an intermediate node, not a leaf node (No in step E1), child nodes (hereinafter, “child nodes A and B”) of the current node are acquired (step E2). Further, referring to the distance between the two child nodes A and B, the operation in step E6 is performed when the distance is a predetermined threshold or less (Yes in step E3). That is, the current node is added to the upper node set.

Further, when the distance between the two child nodes A and B is greater than a predetermined threshold (No in step E2), an upper node generating function (applicable function) is recursively invoked using these child nodes A and B as the current nodes (steps E4 and E5). When all recursive processings are finished, processing of extracting the upper node set is finished.

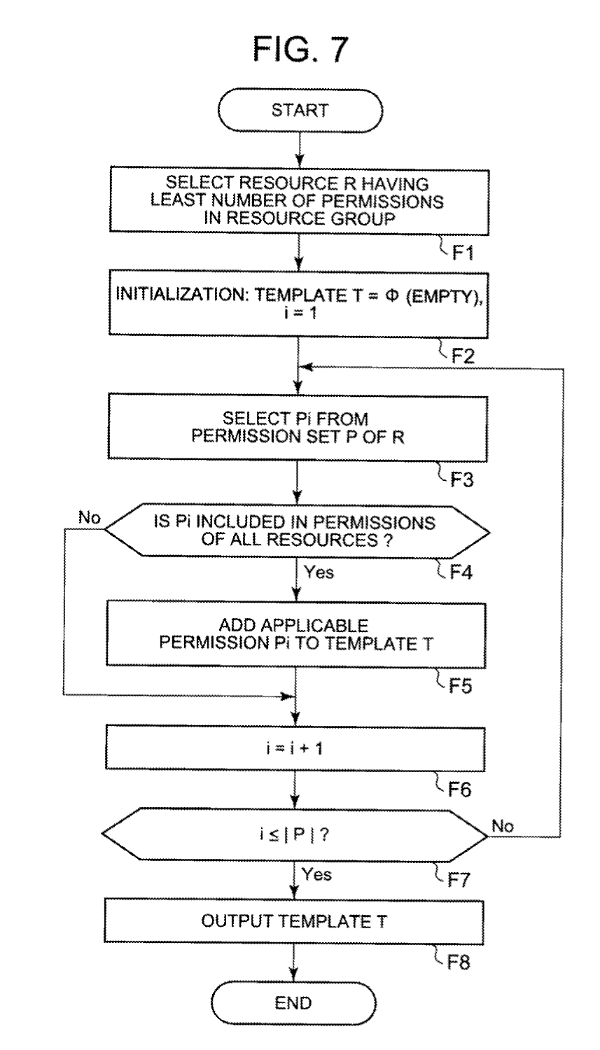

Next, processing of generating a template from a resource group in the template generating means 150 will be described. This processing is executed in step A4 in FIG. 2. FIG. 7 is a flowchart illustrating an example of a processing flowchart of this template generating processing.

As illustrated in FIG. 7, a resource (hereinafter, “resource R”) having the least number of permissions in the resource group is first selected (step F1). Next, a pointer i which indicates one permission included in the resource R and the template T which is outputted as a generation result are initialized (step F2), and the following processing is performed. That is, whether all permissions Pi of the resource R are included in all of other resources is determined, and, if the permission Pi is included in all of other resources, this permission is added to this template T (steps F3 to F7).

When the above processing for all permissions included in the resource R is finished, the template T is outputted and this template generating processing is finished (step F8).

As described above, with the present exemplary embodiment, the resource classifying means 120 generates a resource group characterized by a permission set and creates a policy template based on policy content included in this policy group, so that it is possible to automatically generate a policy template per service. The resource group characterized by this permission set approximates similar to a “group of resources which allows people of the department 1 to browse” a service such as a departmental Web service in operation, so that it is possible to generate a template per service by creating a template per resource group.

Further, a service provided using a resource to be newly added is usually determined in advance, so that, by generating a policy template per service, it is possible to easily select a policy template when a new resource is added.

Further, the number of resources included in one service is learned when a template is created, so that it is possible to provide an analytical support effect of, for example, predicting the frequency of application of the template.

Further, if a binary tree is utilized for resource classification, the distance just needs to be calculated only for a combination of two nodes, so that it is possible to classify resources with a less calculation amount.

Further, the above-described method of generating a resource group can generate a combination of the least numbers of resource groups among combinations of groups having the inter-resource distances in all groups equal to or less than a threshold and, consequently, it is possible to minimize the number of templates to be generated per resource group. This further facilitates selection of a template for the administrator.

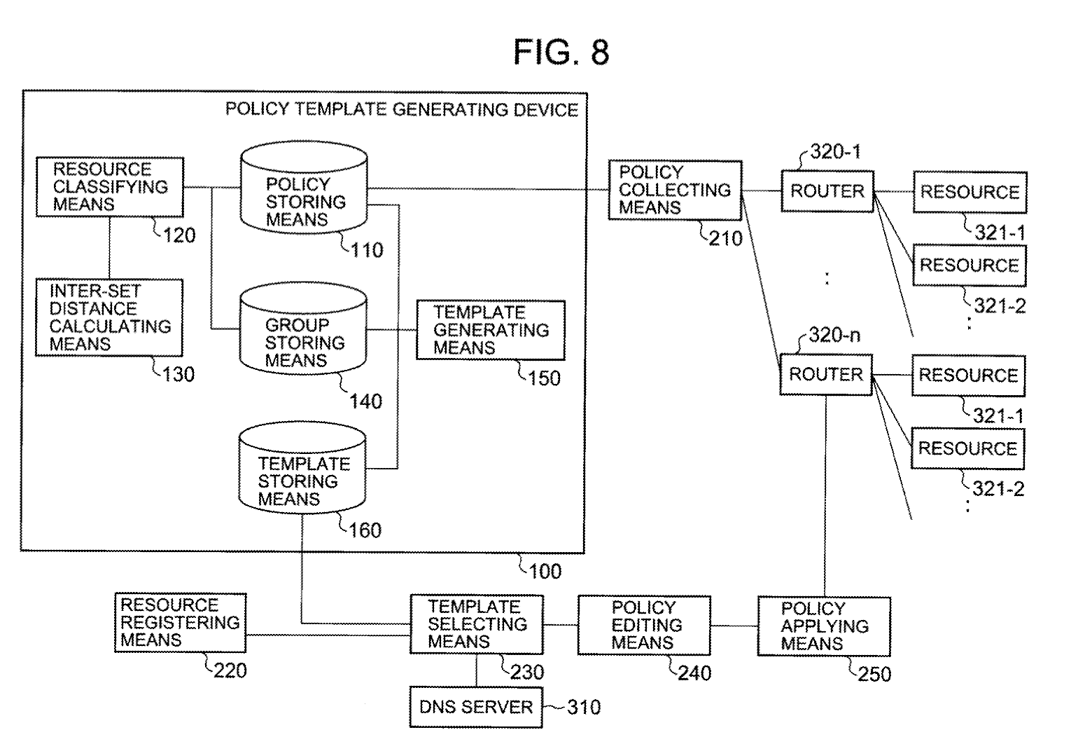

Hereinafter, the operation according to the present exemplary embodiment will be described using a specific example. FIG. 8 is a block diagram illustrating a configuration example of an access right management system having a policy template generating device according to the first example of the present invention. The access right management system illustrated in FIG. 8 includes the policy template generating device 100 illustrated in FIG. 1, policy collecting means 210, resource registering means 220, template selecting means 230, policy editing means 240, policy applying means 230, routers 320-1 to 320-n, each resource 321 (321-1, 321-2 and . . . in FIG. 8) connected to the routers and a DNS server 310.

A system will be described with the present example where a router setting is collected to create a policy template, and the policy is set for a new resource using the created policy template.

The policy collecting means 210 collects from each router 320 an access control policy which is currently set. A protocol for collecting information from, for example, a target device for which a policy is set is implemented in the policy collecting means 210 and a massage is transmitted and received according to this protocol to collect the access control policy which is currently set. The policy collecting means 210 is realized by, for example, a communication control unit which transmits and receives information and a CPU which operates according to a program.

The resource registering means 220 registers a new resource. The resource registering means 220 has a user interface function of, for example, outputting a screen for inputting information of a new resource and receiving information inputted by a keyboard and information according to a mouse operation on the screen to register a new resource. The resource registering means 220 is realized, by for example, a various information input/output unit and a CPU which operates according to a program.

The template selecting means 230 selects a resource to be applied to a new resource. The template selecting means 230 may have a user interface function of outputting the screen which selectably presents information of a template which is held in the system and is applicable to the new resource and receiving information inputted by the keyboard and a selection result according to a mouse operation on the screen to select a resource to be applied to the new resource. The template selecting means 230 is realized, by for example, a various information input/output unit and a CPU which operates according to a program. In addition, with the present example, the template selecting means 230 also functions as a template inputting means which acquires (receives an input of) an access control policy template from the Policy template generating device 100.

The policy editing means 240 edits the template selected by the template selecting means 230 according to a user's operation to create a policy which is actually set. The policy editing means 240 may have an interface function of, for example, displaying and changing the selected template to create a policy. The policy editing means 240 is realized, by for example, a various information input/output unit and a CPU which operates according to a program.

The policy applying means 250 applies a policy (that is, an application policy) which is created based on a template by the policy editing means 240 and actually set, in a target device which is a target to set this policy. For example, a protocol for reflecting the application policy in the target device in the policy applying means 250 and a message is transmitted and received according to this protocol to set the access control policy. The policy applying means 250 is realized by, for example, a communication control unit which transmits and receives information and a CPU which operates according to a program. In addition, with the present example, the application policy is converted in an ACL (Access Control List) format and is set in a router which is a target to set the policy. The policy applying means 250 may, for example, create an ACL which reflects a policy to be added and transmit to each router an ACL setting request according to a predetermined protocol to apply an additional policy.

Next, the operation according to the present example will be described. With the present example, the ACL for network access control of the resources 320 connected to routers 320-1 to 320-n is set respectively in the routers. The policy collecting means 210 collects the ACL set in each of the routers 320-1 to 320-n according to a certain method, and stores the ACL in the policy storing means 110 of the policy template generating device 100 as a policy set which is currently set. The policy collecting means 210 may, for example, transmit to each router an ACL collection request according to the predetermined protocol and receive a response to the request to collect the ACL.

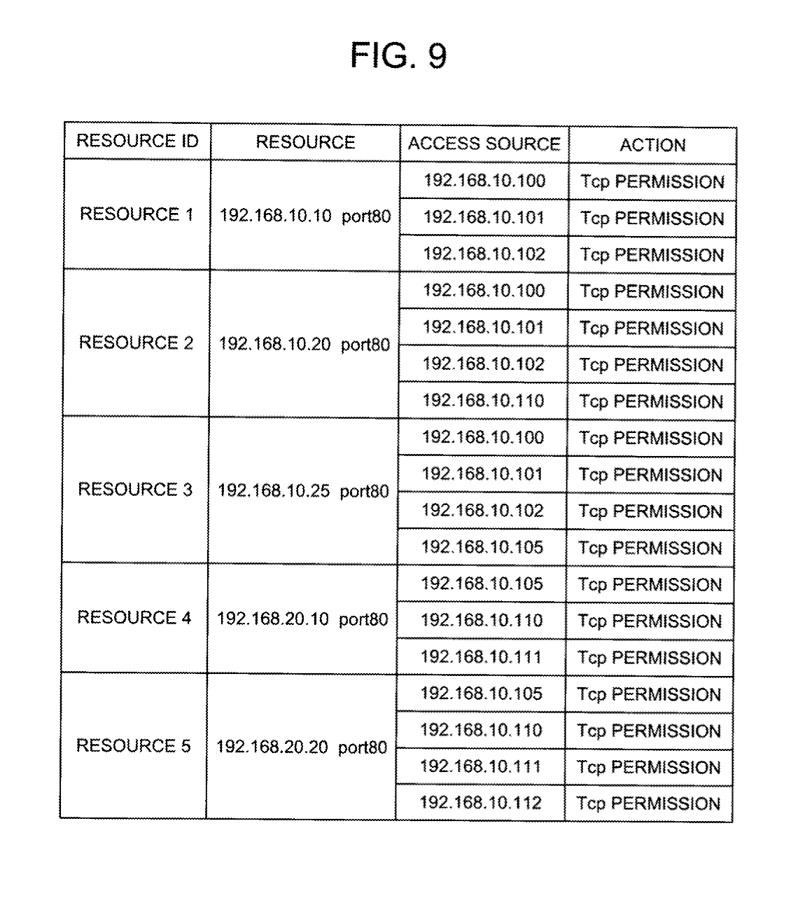

FIG. 9 is an explanatory view illustrating an example of a policy set stored in the policy storing means 110. With the example illustrated in FIG. 9, from which IP address (access source) which protocol is provided (action) to which IP address (resource), that is, an access source and access destination, are associated and stored as a policy set using a resource as a key. In addition, with the example illustrated in FIG. 9, although a resource ID is assigned to each resource to identify a resource, the resource ID is not necessarily required, and the resource, access source and action only need to be stored in association. With the present example, a combination of the access source and action is referred to as “one permission”.

For example, FIG. 9 illustrates that an access control policy including a set of three permissions {“access source IP address” and “action”}={“192.168.10.100” and “Tcp permission”}, {“192.168.10.101” and “Tcp permission”}, {“192.168.10.102” and “Tcp permission”}, in a resource 1 (IP address=“192.168.10.10 port80”).

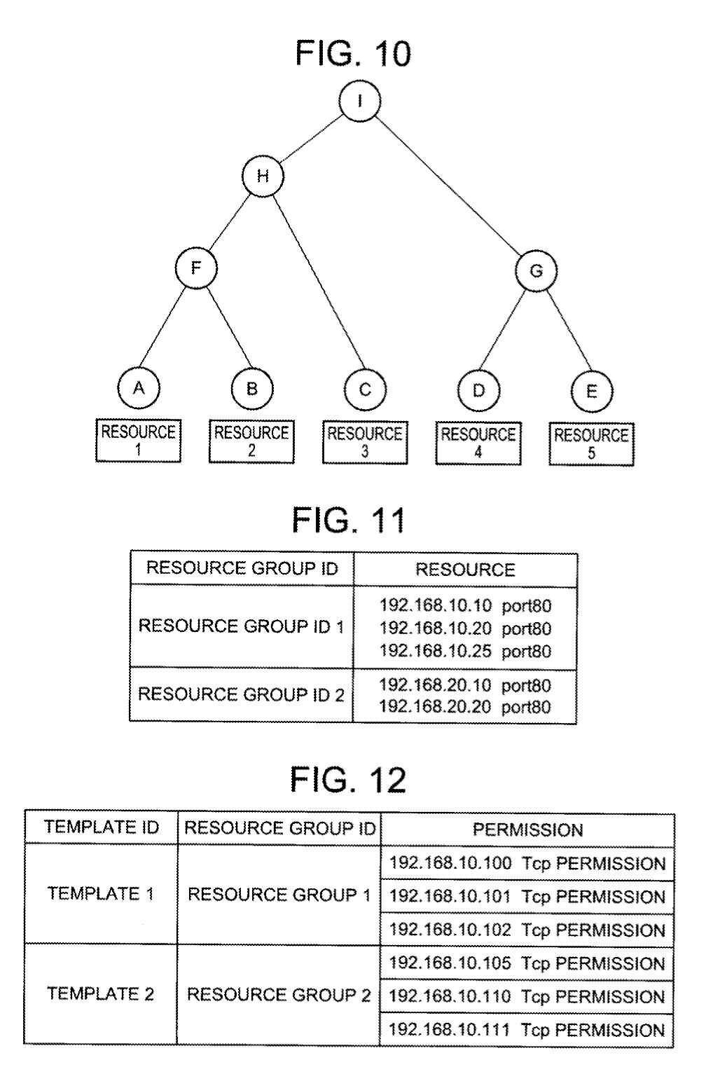

Further, FIG. 10 is an explanatory view illustrating an example of a resource classification tree generated from a policy set illustrated in FIG. 9. With the example illustrated in FIG. 10, by assigning the resource 1 to the node A, resource 2 to the node B, resource 3 to the node C, resource 4 to the node D and resource 5 to the node E, a resource classification tree is generated.

For example, the resource classifying means 120 acquires the permission set per resource from the policy storing means 110 in step B1 and initializes a node set N={A, B, D, E} as leaf nodes (nodes A to E in FIG. 10).

Further, an inter-resource distance is calculated using the inter-set distance calculating means 130 as an inter-node distance associated with each resource (step B2). For example, with the distance between the resource 1 and resource 2 (that is, the distance between the nodes A and B) according to the method illustrated in FIG. 4, the number a of common permissions a is 3, the number b of permissions of the resource 1 is 3 and the number c of permissions of the resource 2 is 4, and is the one seventh of a calculation result according to Math. 1. According to the same calculation, the distance between the resource 1 and resource 3 (distance between the nodes A and C) matches 1/7, the distance between the resource 1 and resource 4 (distance between the nodes A and D) matches 1, the distance between the resource 1 and resource 5 (distance between the nodes A and E) matches 1, the distance between the resource 2 and resource 3 (distance between the nodes B and C) matches 1/4, the distance between the resource 2 and resource 4 (distance between the nodes B and D) matches 1, the distance between the resource 2 and resource 5 (distance between the nodes B and E) matches 3/4, the distance between the resource 3 and resource 4 (distance between the nodes C and D) matches 5/7 and the distance between the resource 4 and resource 5 (distance between the nodes D and E) matches 1/7.

Next, the resource classifying means 120 selects a pair of the closest nodes (step B3). Meanwhile, with the node pair of the closest distance, the inter-node distances of (node A and node B), (node A and node C) and (node D and node E) are 1/7, and only one inter-node distance needs to be selected in case of the same value. Although the selection criterion in case of the same value is not specified in particular, a pair of earlier node numbers (node A and node B) is selected.

Further, a new node (node F in FIG. 10) is generated as a parent node of the node A and node B (step B4). Next, these child nodes A and B are removed from the node set N, and the generated parent node (node F) is added. By this means, the node set N={C, D, E, F} is provided (step B5).

Next, the distance is updated for the new node F. The farthest neighbor distance is used, so that the distance between nodes F and C is the distance between the nodes B and C, and is 1/4. Similarly, the distance between the nodes F and D is the distance between the nodes B and D=1, and the distance between the nodes F and E is the distance between the nodes B and E=1 (step B6). In this case, the element count of the node set is four, and therefore the step returns to step B3 and a pair of the closest nodes is selected again.

By repeating the operations in steps B3 to B6, a node G which is a parent node of the nodes D and. E and a node H which is the parent node of the nodes F and C are added, and a node I which is a parent node of the nodes H and G is further added. At this point of time, the element count of a node set becomes one, and the resource classification tree illustrated in FIG. 10 is structured (step B8).

Next, the resource classifying means 120 performs processing of creating a resource group from the structured resource classification tree. FIG. 11 is an explanatory view illustrating an example of information showing a resource group created as a result of the processing. The information illustrated in FIG. 11 is, for example, stored in the group storing means 140. With the example illustrated in FIG. 11, the group storing means 140 holds information showing the resources belonging to the resource group, in association with an identifier (resource group ID) for identifying the resource group.

Further, hereinafter, processing of extracting the upper node set will be described with reference to a case as an example where the threshold of the distance used for separating a subtree is 0.25. By this means, 75% or more of permissions are shared between all pairs of resources in the resource group.

The resource classifying means 120 first starts processing of determining whether to add a root node I to the upper node set as extracting processing of the upper node set (step D1 in FIG. 6). Meanwhile, the node I is not a leaf node (No in step E1 in FIG. 7), the distance between nodes H and G which are child nodes of the node I is 1 and therefore is greater than the threshold of 0.25 (No in step E3), and the resource classifying means 120 determines that the upper node is not included in the node I.

Hence, the resource classifying means 120 performs processing of determining whether the node H and node G which are child nodes of the node I are further added to the upper node set (steps E4 and E5). Meanwhile, decision processing from step. E1 will be repeated using the node H or node G as a current node.

When decision processing is performed again using the node H as a current node, the node H is not a leaf node (No in step E) and the distance between the nodes F and C which are child nodes is 0.25 (Yes in step E3), and therefore the resource classifying means 120 determines to include the node H in the upper node set (step E6). Further, when decision processing is performed using the node G as a current node, the node G is not a leaf node (No in step E), the distance between the nodes D and E which are child nodes is 0.14 ( 1/7) (Yes in step E3), and therefore the resource classifying means 120 determines to include the node G in the upper node set (step E6). According to this processing, {node H and node G} are outputted as an upper node set (step E7).

Next, a resource group is generated from a subtree which uses each element of the upper node set as a root node. With the present example, a leaf node set {node A, node B and node C} included in the subtree which uses the node H as a root node is first generated (step D3). Further, a resource ‘set {resource 1, resource 2 and resource 3} associated with the generated leaf node set is generated as a resource group 1 (step D4).

Next, a leaf node set {node D and node E} included in a subtree which uses the node G as a root node is generated this time (step D3), and a resource group {resource 4 and resource 5} associated with the generated leaf node set is generated as a resource group 2 (step D4).

Information showing the resource groups 1 and 2 which are finally generated is stored in the group storing means 140 as illustrated in FIG. 11 (step A3).

Next, a specific example of processing of generating a policy template from a resource group in the template generating means 150 will be described.

The template generating means 150 first generates a template associated with the resource group 1. As processing of generating a template associated with the resource group 1, the resource 1 which has the least number of permissions among resources of the resource group 1 is first selected (step F1). Next, whether each permission included in the selected resource 1 is included in all other resources of the same resource group 1 is determined (step F3).

Meanwhile, whether the permission {“192.168.10.100” and “Tcp permission”} (hereinafter “permission 1-1”) of the resource 1 is included in permission sets of the resource 2 and resource 3 is determined (step F4). With the present example, it is determined in step F4 that the permission 1-1 is included in the permission sets of the resource 2 and resource 3, so that the permission 1-1 is added to a template (step F5).

According to the same processing, decision is also made for two other permissions {“192.168.10.100” and “Tcp permission”} (hereinafter “permission 1-2”), and {“192.168.10.100” and “Tcp permission”} (hereinafter “permission 1-3”) of the resource 1. With the present example, both of the two permissions are included in the permission sets of the resource 2 and resource 3, and therefore the permissions 1-2 and 1-3 are added to templates.

When the above decision processing of all permissions of the resource 1 is finished, a template having a permission set {permission 1-1, permission 1-2 and permission 1-3} is generated as a template associated with the resource group 1 at this point of time, and is outputted (step F8).

According to the same processing, a template associated with the resource group 2 is generated. With the present example, according to processing of generating the template associated with the resource group 2, the resource 4 having the least number of permissions among the resources of the resource group 2 is first selected, and whether each permission {“192.168.10.105” and “Tcp permission”} (hereinafter “permission 2-1”), and {“192.168.10.110” and “Tcp permission”} (hereinafter “permission 2-2”) and {“192.168.10.111” and “Tcp permission”} (hereinafter “permission 2-3”) is included in all resources (resource 5 with the present example) of the resource group 2.

As a result, all permissions are included in the permission set of the resource 5, and therefore permissions 2-1, 2-2 and 2-3 are added as templates. When decision processing of all permissions of the resource 4 is finished, the template having a permission set of (permission 2-1, permission 2-2 and permission 2-3) is generated as a template associated with the resource group 2 at this point of time, and therefore is outputted (step F8).

FIG. 12 is an explanatory view illustrating an example of a policy template generated according to this processing. FIG. 12 illustrates an example of a policy template generated to be associated with the resource group illustrated in FIG. 11. As illustrated in FIG. 12, for example, an ID (template ID) for identifying a template, a resource group ID for identifying an associated resource group and information showing a permission set included in the template may be associated as information showing a policy template, and stored in the template storing means 160. In addition, the resource group ID is information used to refer to information of resources included in the resource group, and utilized as index information for the group storing means 140. In addition, instead of the resource group ID, information of resources included in the resource group may be directly included.

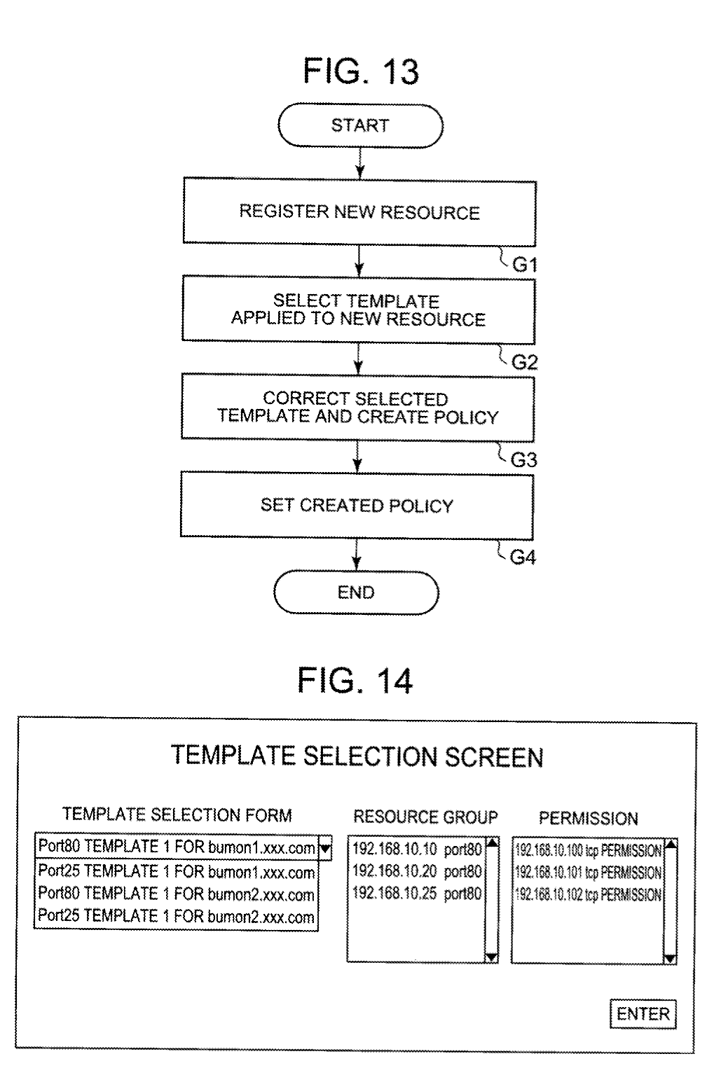

FIG. 13 is a flowchart illustrating an example of a policy setting operation of setting a policy for a new resource utilizing a policy template generated in this way. With the example illustrated in FIG. 13, the resource registering means 220 first registers a new resource according to the administrator's operation (step G1). In step G1, an IP address of a new resource and, if necessary, information of a port number is inputted by the administrator through the resource registering means 220. For example, “192.160.10.30 port80” which is a Web server for a new department 1 is added as a new resource.

Next, the template selecting means 230 makes the administrator to select a policy template applied to a new resource (step G2). FIG. 14 illustrates an example of a user interface (more specifically, template selection screen) provided by the template selecting means 230. As illustrated in FIG. 14, the template selection screen preferably displays information of an associated resource group and permission when a template to be utilized is selected.

Further, the template selection screen preferably displays a template name which facilitates selection of a template, and the template name is preferably given based on characteristics of the associated resource group and permission set. The template name may utilize, for example, a port number which is common in the resource group or a domain of an access source which can be acquired using the DNS server 310.

A template 1 in FIG. 11 is common when the resource is port80, and is common when the domain of the access source inquired using the DNS server 310 is a “bumonl.xxx.com” domain. In this case, the template name is named as “port80 template for bumonl.xxx.com”, so that the administrator can read the Web server template for the department 1 upon selection.

When a template to be applied is selected, the template editing means 240 edits the selected template to create a policy actually set for a new resource (step G3). In addition, when the template is applied as is, processing only needs to be finished without performing any processing in particular as the editing operation.

When a policy which is actually set is created, the policy applying means 250 sets the created policy in the router (step G4). By setting the policy in the router, a network access control setting for the new resource is finished.

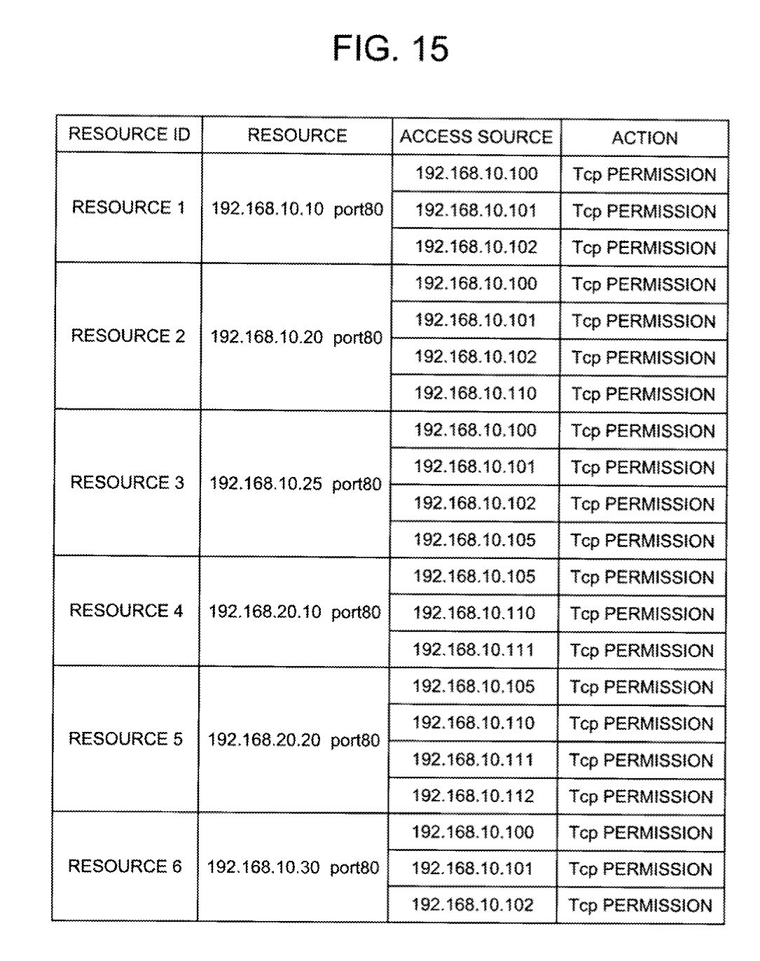

When, for example, the template 1 is selected for the resource “192.168.10.30 port80” used as the Web server for the department 1 and a policy is created without edition, the policy set in the router is as illustrated in FIG. 15. FIG. 15 is an explanatory view illustrating an example of a policy set in a router when a resource is added utilizing the template 1 illustrated in FIG. 12. With the example illustrated in FIG. 15, permission sets {{“192.168.10.100” and “Tcp permission”}, {“192.168.10.101” and “Tcp permission”} and {“192.168.10.102” and “Tcp permission”}} for the “192.168.10.30 port80” are added to the policy set illustrated in FIG. 9 as a resource ID=6.

With the present example, as long as a configuration is employed which collects an existing policy and automatically generates a policy template, it is possible to easily set the policy to a new resource without preparation in advance.

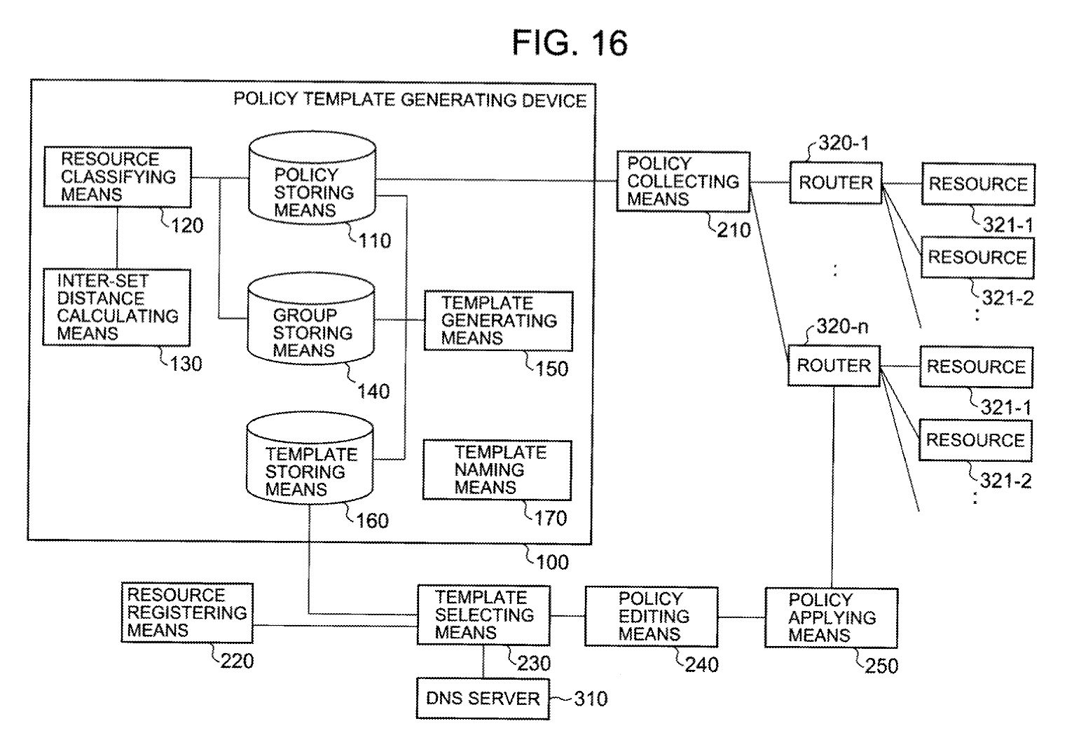

Further, FIG. 16 is a block diagram illustrating another configuration example of an access right management system provided in the policy template generating device according to a second example of the present invention. As illustrated in FIG. 16, the template naming means 170 may be further added to the configuration according to the present example.

The template naming means 170 assigns a name to the created template according to the user's operation. The template naming means 170 has a user interface function of, for example, presenting information of the created template, outputting a screen for inputting the name assigned to the template, and receiving information inputted by a keyboard and information according to a mouse operation on the screen to input a template name and assign a template. The template naming means 170 is realized by, for example, a various information input/output unit and a CPU which operates according to a program.

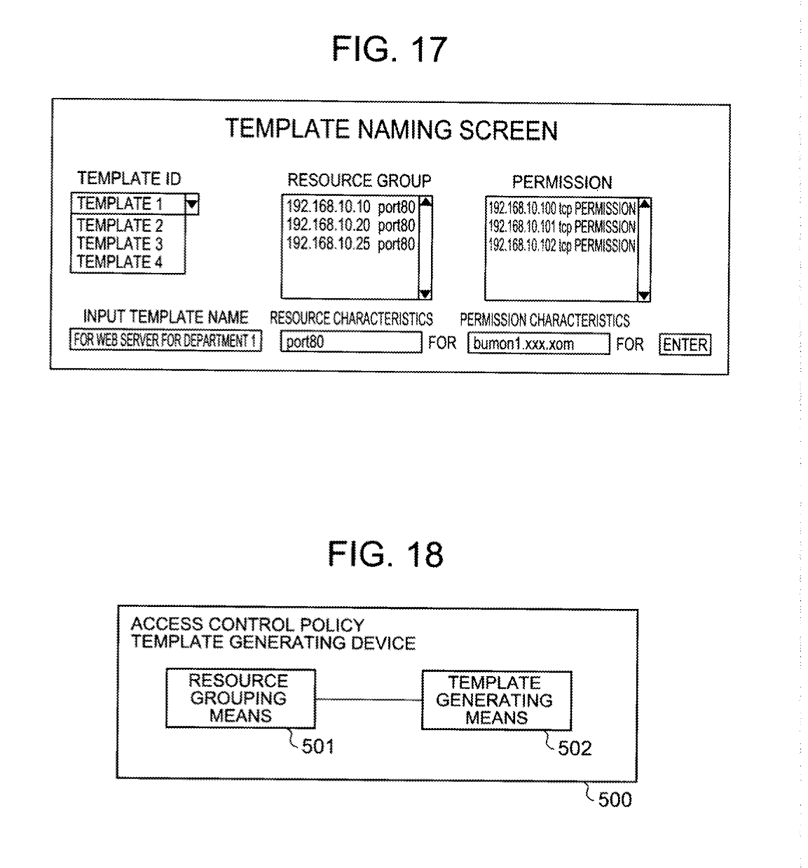

FIG. 17 is an explanatory view illustrating an example of a user interface (more specifically, template naming screen) provided by the template naming means 170. As illustrated in FIG. 17, the template naming screen preferably displays not only information of the created template, but also resource characteristics (for example, port number) and permission characteristics (for example, access source domain) as naming support information.

The administrator may determine a template name which facilitates selection of the template, based on naming support information presented by the template naming means 170, and input the name. For example, in case of a template having a common access source domain of “bumonl.xxx.com” and common resource of “port80”, the template may be named as “the Web server template for the department 1”.

In addition, although the example illustrated in FIG. 17 has been described where the policy template generating device 100 has the template naming means 170, the template naming means 170 may be mounted as a device different from the policy template generating device 100. The means of the device to be actually mounted is not limited in particular.

Further, the template naming means 170 may have not only a function of assigning a template name according to the user's operation but also a function of automatically determining a template name based on a resource group and permission set characteristics as described above using the template name displayed on the template selection screen according to the first example. In this case, the template naming means 170 extracts resource characteristics included in the resource group and permission set characteristics, and determines a combination of expressions showing these characteristics as a template name.

Thus, by assigning a name to the template using the template naming means 170, the administrator can more easily select the template.

Next, the outline of the present invention will be described. FIG. 18 is a block diagram illustrating the outline of the present invention. An access control policy template generating device 500 according to the present invention has resource grouping means 501 and template generating means 502.

When a plurality of access control policies having access control content defined for resources are given, the resource grouping means 501 (for example, the resource classifying means 120 (including inter-set distance calculating means 130)) classifies each resource into one or more groups based on the similarity between resource specific access control policy sets calculated using, as a comparison target, the access control content of the access control policies included in the resource specific access control policy sets of the same access control policy among a plurality of access control policies.

The template generating means 502 (for example, template generating means 150) generates an access control policy template based on definition content of access control policies defined for resources included in the resource group, per resource group which is a group of resources classified by the resource grouping means 501.

The template generating means 502 may, for example, generate an access'control template including access control content which is common between access control policies defined for resources included in this resource group per resource group.

Further, when an access control policy is given which includes, for example, information showing resources and information showing access control content defined according to an access source which accesses the resource and an access method of permitting an access to the resource, the resource grouping means 501 may classify each resource into one or more groups, based on the similarity between the resource specific access control policy sets calculated using, as a comparison target, information of an access source of access control content of the access control policies included in the resource specific access control policy sets having the access control policies of the same resource.

Further, as the similarity between resource specific access control policy sets, the resource grouping means 501 may use an exponent which increases following an increase of an access control policy having access control content which is not common between The resource specific access control policy sets.

Further, the resource grouping means 501 may structure a binary tree which has leaf nodes associated one to one with the resources indicated by the plurality of given access control policies and which is arranged such that a path length between nodes is shorter when the similarity between the resource specific access control policy sets is smaller, and classify resources such that the inter-leaf node distance in the structured binary tree is a predetermined distance or less.

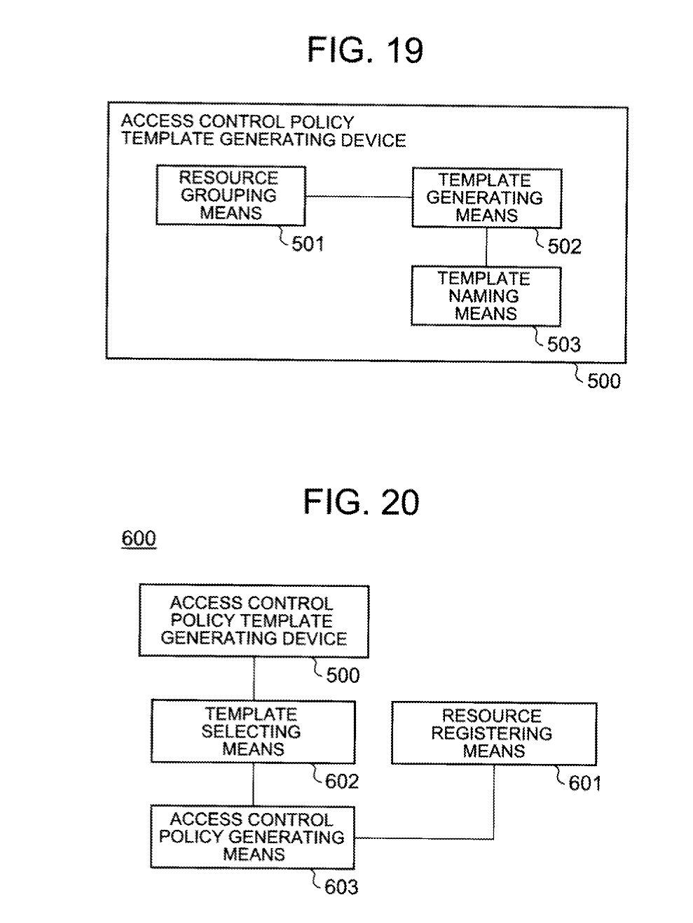

Further, FIG. 19 is a block diagram illustrating another configuration example of an access control policy template generating device according to the present invention. As illustrated in FIG. 19, the access control policy template generating device 100 may further have template naming means 503.

The template naming means 503 determines the name to be assigned to the generated access control policy template, based on characteristics of the'group of the resources associated when the access control policy template is generated and characteristics of access control content included in this access control policy template.

Further, FIG. 20 is a block diagram illustrating a configuration example of the access control policy management system 600 which is an example of using the access control policy template generating device 500 according to the present invention.

The access control policy management system 600 includes the above access control policy template generating device 500, and further includes resource registering means 601, template selecting means 602 and access control policy generating means 603.

The resource registering means 601 (for example, resource registering means 220) registers a new resource. The template selecting means 602 (for example, template selecting means 230) selects an access control policy template which is registered by the resource registering means 601 and is applied to the new resource, according to the user's operation from the access control policy template generated by the access control policy template generating device 500.

The access control policy generating means 602 (for example, policy editing means 240) edits the access control policy template selected by the template selecting means 602 according to the user's operation, and generates an access control policy which is applied to the new resource registered in the resource registering means 501.

Although the present invention has been described with reference to the exemplary embodiment and examples, the present invention is by no means limited to the above exemplary embodiment and examples. Various changes which one of ordinary skill in the art can understand within the scope of the present invention can be made to the configuration and details of the present invention.

This application claims priority to Japanese Patent Application No 2009-96126, filed on Apr. 10, 2009, the entire contents of which are incorporated by reference herein.

### INDUSTRIAL APPLICABILITY

The present invention is suitably applied for use to support policy management for an access right management system.

### REFERENCE SIGNS LIST

100 Policy template generating device
110 Policy storing means
120 Resource classifying means
130 Inter-set distance calculating means
140 Group storing means
150 Template generating means
160 Template storing means
170 Template naming means
210 Policy collecting means
220 Resource registering means
230 Template selecting means
240 Policy editing means
250 Policy applying means

1-19. (canceled)

20. An access control policy template generating device comprising:
a resource grouping unit which, when a plurality of access control policies including access control content defined for resources are given, classifies each resource into one or more groups based on a similarity between resource specific access control policy sets calculated using, as a comparison target, the access control content of the access control policies included in the resource specific access control policy sets including access control policies of a same resource among the plurality of access control policies; and
a template generating unit which generates an access control policy template based on definition content of the access control policies defined for the resources included in a resource group per resource group which is a group of the resources classified by the resource grouping unit.

21. The access control policy template generating device according to claim 20, wherein the template generating unit generates per resource group the access control template including access control content which is common in the access control policies defined for the resources included in the group of the resources.

22. The access control policy template generating device according to claim 20, wherein, when an access control policy is given which includes information showing the resources and information showing the access control content defined by an access source which accesses the resources and an access method of permitting the access to the resources, the resource grouping unit classifies each resource into one or more groups based on the similarity between the resource specific access control policy sets calculated using, as the comparison target, information of the access source of the access control content of the access control policies included in the resource specific access control policy sets including the access control policies of the same resource.

23. The access control policy template generating device according to claim 20, wherein, as the similarity between the resource specific access control policy sets, the resource grouping unit uses an exponent which increases following an increase of the access control policy including the access control content which is not common between the resource specific access control policy sets.

24. The access control policy template generating device according to claim 20, wherein the resource grouping unit structures a binary tree which includes leaf nodes associated one to one with the resources indicated by the plurality of given access control policies and which is arranged such that a path length between nodes is shorter when the similarity between the resource specific access control policy sets is smaller, and classifies the resources such that the inter-leaf node distance in the structured binary tree is a predetermined distance or less.

25. The access control policy template generating device according to claim 20, further comprising a template naming unit which determines a name to be assigned to the generated access control policy template, based on characteristics of the group of the resources associated when the access control policy template is generated and characteristics of access control content included in the access control policy template.

26. An access control policy management system comprising the access control policy template generating device according to claim 20, the access control policy management system comprising:
a resource registering unit which registers a new resource;
a template selecting unit which selects an access control policy template to be applied to the new resource registered in the resource registering unit from the access control policy template generated by the access control policy template generating device according to a user's operation; and
an access control policy generating unit which edits the access control policy template selected by the template selecting unit according to the user's operation, and generates an access control policy to be applied to the new resource registered in the resource registering unit.

27. An access control policy generating method comprising:
when a plurality of access control policies including access control content defined for resources are given, classifying each resource into one or more groups based on a similarity between resource specific access control policy sets calculated using, as a comparison target, the access control content of the access control policies included in the resource specific access control policy sets including access control policies of a same resource among the plurality of access control policies; and
generating an access control policy template based on definition content of the access control policies defined for the resources included in a resource group per resource group which is a group of the classified resources.

28. The access control policy generating method according to claim 27, further comprising generating per resource group the access control template including access control content which is common in the access control policies defined for the resources included in the group of the resources.

29. The access control policy generating method according to claim 27, further comprising, when an access control policy is given which includes information showing the resources and information showing the access control content defined by an access source which accesses the resources and an access method of permitting the access to the resources, classifying each resource into one or more groups based on the similarity between the resource specific access control policy sets calculated using, as the comparison target, information of the access source of the access control content of the access control policies included in the resource specific access control policy sets including the access control policies of the same resource.

30. The access control policy generating method according to claim 27, wherein, as the similarity between the resource specific access control policy sets, an exponent is used which increases following an increase of the access control policy including the access control content which is not common between the resource specific access control policy sets.

31. The access control policy generating method according to claim 27, further comprising:
when the resources are classified into one or more groups, structuring a binary tree which includes leaf nodes associated one to one with the resources indicated by the plurality of given access control policies and which is arranged such that a path length between nodes is shorter when the similarity between the resource specific access control policy sets is smaller; and
classifying the resources such that the inter-leaf node distance in the structured binary tree is a predetermined distance or less.

32. The access control policy generating method according to claim 27, further comprising determining a name to be assigned to the generated access control policy template, based on characteristics of the group of the resources associated when the access control policy template is generated and characteristics of access control content included in the access control policy template.

33. A computer readable information recording medium storing an access control policy generating program, when executed by a processor, including a storage unit which stores a plurality of access control policies including access control content defined for resources, performs a method for
resource grouping processing for classifying each resource into one or more groups based on a similarity between resource specific access control policy sets calculated using, as a comparison target, the access control content of the access control policies included in the resource specific access control policy sets including access control policies of a same resource among the plurality of access control policies; and
template generating processing for generating an access control policy template based on definition content of the access control policies defined for the resources included in a resource group per resource group which is a group of the classified resources.

34. The computer readable information recording medium according to claim 33, further comprising in the template generating processing, generate per resource group the access control template including the access control content which is common in the access control policies defined for the resources included in the group of the resources.

35. The a computer readable information recording medium according to claim 33, the processor including a storage unit which stores an access control policy including information showing the resources and information showing the access control content defined by an access source which accesses the resources and an access method of permitting the access to the resources to,
in the resource grouping processing, classifying each resource into one or more groups based on the similarity between the resource specific access control policy sets calculated using, as the comparison target, information of the access source of the access control content of the access control policies included in the resource specific access control policy set including the access control policies of the same resource.

36. The computer readable information recording medium according to claim 33, wherein, as the similarity between the resource specific access control policy sets, an exponent is used which increases following an increase of the access control policy including the access control content which is not common between the resource specific access control policy sets.

37. The computer readable information recording medium according to claim 33, further comprising
processing of structuring a binary tree which includes leaf nodes associated one to one with the resources indicated by the plurality of given access control policies and which is arranged such that a path length between nodes is shorter when the similarity between the resource specific access control policy sets is smaller; and
processing of classifying resources such that the inter-leaf node distance in the structured binary tree is a predetermined distance or less.

38. The computer readable information recording medium according to claim 33, further comprising
template naming processing for determining a name to be assigned to the generated access control policy template, based on characteristics of the group of the resources associated when the access control policy template is generated and characteristics of access control content included in the access control policy template.
